(19) United States
(12) Patent Application Publication
(10) Pub. No.: US 2025/0020403 A1
(43) Pub. Date: Jan. 16, 2025

(54) FREEZE-DRYING TRAY

(71) Applicant: Jürgen Kögel, Burrweiler (DE)

(72) Inventor: Jürgen Kögel, Burrweiler (DE)

(21) Appl. No.: 18/769,658

(22) Filed: Jul. 11, 2024

(30) Foreign Application Priority Data
Jul. 13, 2023 (DE) 102023118662.0

(51) Int. Cl. F26B 25/18; F26B 5/06

(52) U.S. Cl. CPC F26B 25/18; F26B 5/06

(57) ABSTRACT

In the case of a freeze-drying tray for producing freeze-dried products, in particular pharmaceutical products, it is important to monitor the drying process as well as possible. This is accomplished by the use of temperature sensors. In order to place these sensors optimally, the invention provides for allowing a measuring sensor sleeve to protrude into the freeze-drying tray. This type of a measuring sensor sleeve, however, consists preferably of polypropylene and therefore must not be fused with the filter cloth made of polytetrafluorethylene. The invention therefore provides for achieving this type of fusing by means of a heated tool welding and thereby create an actually water-tight connection. A corresponding connection is thereby created on the edges of the filter cloth, which are connected to the tray frame.

### REFERENCE TO PENDING PRIOR PATENT APPLICATION

This patent application claims benefit of German Patent Application No. 102023118662.0, filed Jul. 13, 2023, which patent application is hereby incorporated herein by reference.

### FIELD OF THE INVENTION

The present invention relates to a freeze-drying tray, comprising a tray frame having a sealable access opening and a circumferential wall, which on a free edge has a first projection, on which a filter cloth is circumferentially affixed.

### BACKGROUND OF THE INVENTION

This type of freeze-drying tray is already previously known from DE 20 2019 102 094 U1. Essential for the use of these types of tray-shaped containers is the sterile condition thereof and the avoidance of the penetration of particles from the environment. Furthermore, reference must be made to WO 2014/165222 A1 and to WO 2006/013360 A1.

Thus, a tray system is known for use in freeze-drying methods that are used in the course of freeze-drying, in other words, so-called lyophilization. This type of tray system has a tray for feeding the lyophilizate, over which a filter cloth is arranged in a holder. In doing so, it must be ensured that this type of a filter cloth is sterilized beforehand in order to prevent the inclusion of microbes, which would contaminate the lyophilizate. In such a solution, the tray system is fabricated of stainless steel, for example, and is therefore reusable, whereas nonetheless the filter cloth must be replaced and disposed of after use.

However, this requires appropriate capacity for sterilization at the place of use, which is not necessarily a given. As a result, work is performed on a day-to-day basis either with considerable time and effort or else with a reduced level of quality, where sterilization of the filter cloth is possibly neglected.

Furthermore, a product with the name “Lyoguard” is known, in which a plastic tray system used there is directly fused with a filter cloth. However, this type of solution is certainly not reusable. However, carrying out a fusing primarily among the identical materials is known. As a result, the selection of materials for producing the tray and filter cloth is very restricted.

In the course of freeze-drying it is useful to precisely record the temperature of the products enclosed in the individual freeze-drying trays, in order to be able to manage the withdrawal of thermal energy during the process in a targeted manner. The closer a temperature sensor is able to be brought to the product, the more precise the temperature recording during the process can be, ideally introducing the temperature sensor into the product if possible.

### SUMMARY OF THE INVENTION

Against this background, the problem underlying the present invention is proposing a freeze-drying tray, with which a temperature measurement can be carried out as close as possible to the product, which, however, is nevertheless sealed in a liquid-tight manner.

This is achieved by a freeze-drying tray according to the features of claim 1. Further useful embodiments of this type of a freeze-drying tray can be taken from the following dependent claims.

Provided in this respect is a freeze-drying tray, comprising a tray frame having a sealable access opening and a circumferential wall, which on a free edge has a first projection, on which a filter cloth is circumferentially affixed. According to the invention, this type of a freeze-drying tray is characterized in that the filter cloth has a passage opening, through which a measuring sensor sleeve is passed or on which it rests, wherein the measuring sensor sleeve has a connecting edge, which surrounds an entrance opening for the insertion of a temperature sensor, and the filter cloth is sealingly fused and stamped along its outer edge with the tray frame and around the passage opening with the adjoining material of the measuring sensor sleeve in each case using heated tool welding.

Despite different materials for the measuring sensor sleeve and filter cloth, this results in a water-tight and mechanically resilient connection. Because of the protruding of the measuring sensor sleeve, a temperature sensor can be introduced up into the interior of the product and precisely monitor the temperature profile during the freeze-drying process. The measuring sensor sleeve can thereby optionally either be placed on the passage opening or be passed through it and be fused and pressed with the heating element, in other words, be connected mechanically.

In an especially preferred embodiment, it can be provided that opposing edges of the first projection are connected to each other via at least one transverse bar, preferably in a cruciform shape, which for their part have a passage opening, which corresponds to the passage opening of the filter cloth and through which the measuring sensor sleeve is passed or on which it rests. A fixed structure is thereby created, on which the measuring sensor sleeve can be supported, so that it is not bent. This also minimizes the mechanical stress during the insertion or removal of the temperature sensor.

Furthermore, it can be provided that a screw connection is assigned to the measuring sensor sleeve for a precisely positioned fastening of a temperature sensor that can be inserted through the screw connection into the measuring sensor sleeve. This can be solved in an especially useful manner by a Panzergewinde (steel conduit thread). For one, this type of a screw connection ensures a mechanical hold on the side opposite from the measuring sensor sleeve, and, on the other hand, however, the temperature sensor can thereby be held at the correct depth by means of the screw connection with the Panzergewinde (steel conduit thread), and affixed there. A distortion of the measuring result from the temperature sensor shifting is thereby prevented.

Especially preferably, the tray frame and/or the measuring sensor sleeve can be produced in each case from polyethylene, polypropylene or polyester. When melting the plastic, a molten mass forms, which under compressive pressure bonds with the PTFE fabric of the filter cloth to form a tight and mechanically resilient connection. A type of interlocking of the plastic in the fabric develops.

With further advantage, it can be provided that the measuring sensor sleeve has a metallic contact surface on its free end. As a result, the temperature sensor can be pushed forward up to the contact surface, which facilitates a good heat-conducting contact therein in the interior of the freeze-drying tray.

In a further specific embodiment, it can be provided that the filter cloth is produced either from a polytetrafluorethylene membrane, which is laminated on a polytetrafluorethylene carrier, or alternatively is produced from a polytetrafluorethylene membrane, which is laminated on a carrier made of polyethylene, polypropylene or polyester.

Furthermore, it can be provided that the tray frame has, on its side opposite from the first projection, another free edge with a second projection, on which a cover film is affixed, preferably welded on. This type of a cover film represents an especially usefully base for the freeze-drying tray. Because said freeze-drying tray is seldom situated completely level in the freezing unit, a film that fits tight against the cooling surface allows for a close contact and will dissipate the heat especially beneficially from the interior of the freeze-drying tray.

In doing so, it can be especially advantageous if the cover film is produced from the same material as the tray frame. In this case, the fusing of identical materials is then accomplished without a problem using conventional methods, such as for example by ultrasonic welding.

Alternatively, however it is also possible, even though it is not preferred, if the tray frame forms a closed cover on its side opposite from the first projection. Indeed this is more mechanically stable, but it transmits the heat less well than a cover film.

The invention described in the foregoing will be explained in greater detail in the following based on an embodiment.

### BRIEF DESCRIPTION OF THE DRAWINGS

The drawing shows:

FIG. 1 A perspective top view of a freeze-drying tray from below of the cover film,

FIG. 2 A perspective representation of a measuring sensor sleeve as a detail of the freeze-drying tray according to FIG. 1 with a bar for the connection of the opposing edges of a first projection,

FIG. 3 A perspective representation of an alternative design of the freeze-drying tray according to FIG. 2 without a bar, and

FIG. 4A perspective representation of a screw connection as a detail of the freeze-drying tray according to FIG. 1.

### DETAILED DESCRIPTION OF THE PREFERRED EMBODIMENTS

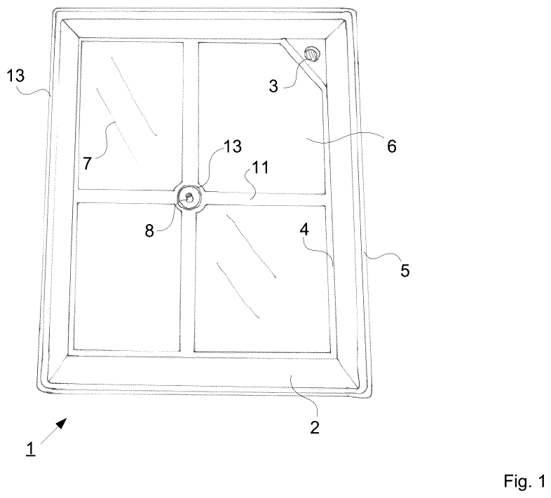

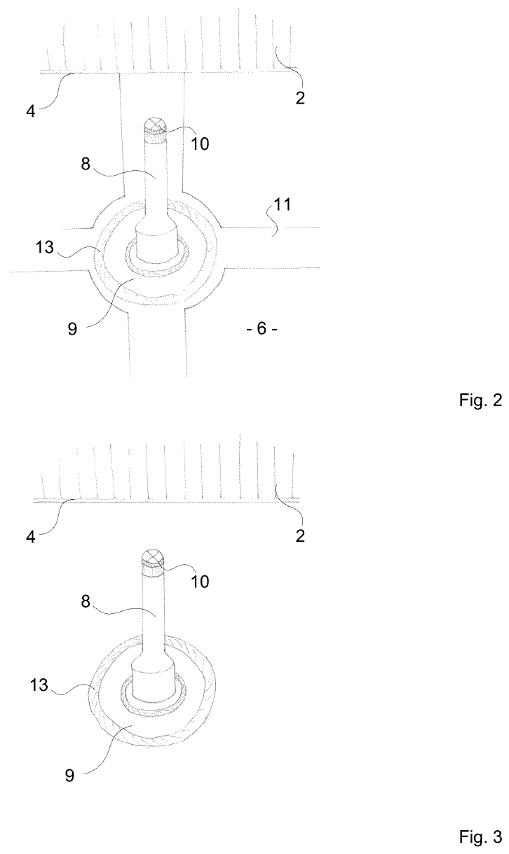

FIG. 1 shows a freeze-drying tray 1 (containment system for drying), which has a tray frame 2 as a supporting structure. The tray frame 2 forms a wall, which surrounds the freeze-drying tray 1 and is able to accommodate a product for freeze-drying. Together with a filter cloth 6 made of PTFE, which is produced from a PTFE membrane, which is laminated onto a PTFE fabric, and a cover film 7, which is transparent in the present case and is indicated only by a cross-hatching, the tray frame 2 surrounds a closed accommodation space of 600×500×55 mm for the product that is to be dried. Said product is introduced via a sealingly sealable access opening 3.

Once the freeze-drying tray 1 with the product has been put into a freezing device, the product is supposed to be freeze-dried. The liquid is supposed to escape via the filter cloth 6, but conversely nothing should be able to reach the product. The filter cloth 6 is therefore welded circumferentially on the tray frame 2 by means of the heated tool welding in that the plastic of the tray frame 2 is fused and pressed with the fabric of the filter cloth 6. As a surface for this, the tray frame 2 provides a first projection 4, which in this case projects inwardly, for fusing with the cover film 7 [and] a second projection 5, which projects outwardly, so that the tray frame appears roughly Z-shaped in cross section.

If the freeze-drying tray 1 is put into a freezing device, the cover film 7 comes into a close arrangement with a heat-extracting surface and is therefore able to dissipate the heat especially effectively. The moisture is able to exit from the freeze-drying tray 1 through the filter cloth 6.

In order to facilitate the most effective possible temperature measurement, and be able to appropriately regulate the cooling process, the freeze-drying tray 1 provides for a measuring sensor sleeve 8 positioned centrally in the freeze-drying tray 1, into which measuring sensor sleeve a temperature sensor can be inserted. As a result, the temperature sensor is able to record the temperature in the core of the product, so that the freeze-drying process can be managed as precisely as possible. For this, the measuring sensor sleeve 8 is also either directly fused with the filter cloth 6, as shown in FIG. 3, or else is fused with a bar 11, which is tensioned between the edges of the first projection 4 in a cruciform shape. The bar 11 for its part is then fused with the filter cloth 6. It is hereby possible to pass the measuring sensor sleeve 8 also through a passage opening of the bar 11 and/or of the filter cloth, so that the fusings 13 can be arranged differently, but have the same effect.

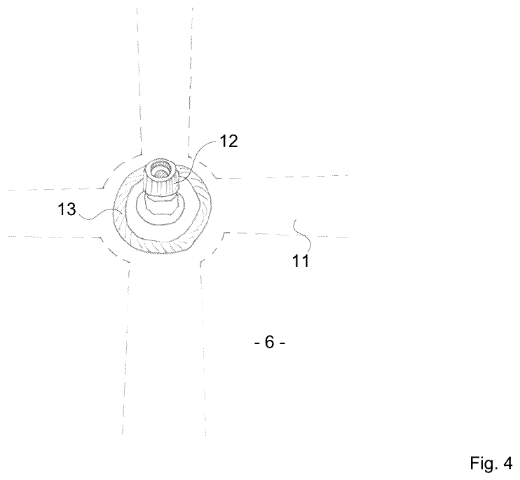

The measuring sensor sleeve 8 can be produced from polypropylene and have a metallic contact surface 10, so that the temperature sensor obtains a good heat-conducting connection in the interior of the freeze-drying tray 1 through the contacting with the contact surface 10. Situated on the rear side of the measuring sensor sleeve 8, as depicted in FIG. 4, is a screw connection 12 with a Panzergewinde (steel conduit thread), which is used to secure the temperature sensor at a depth and hold it there.

Consequently, the foregoing describes a freeze-drying tray, with which a temperature measurement can be carried out as close as possible to the product, which, however, is nevertheless sealed in a liquid-tight manner.

### LIST OF REFERENCE NUMBERS

1 Freeze-drying tray
2 Tray frame
3 Access opening
4 First projection
5 Second projection
6 Filter cloth
7 Cover film
8 Measuring sensor sleeve
9 Connecting edge
10 Contact surface
11 Bar
12 Screw connection
13 Fusing

What is claimed is:

1. A freeze-drying tray, comprising a tray frame (2) having a sealable access opening (3) and a circumferential wall, which on a free edge has a first projection (4), on which a filter cloth (6) is circumferentially affixed,
characterized in that the filter cloth (6) has a passage opening, through which a measuring sensor sleeve (8) is passed or on which it rests, wherein the measuring sensor sleeve (8) has a connecting edge (9), which surrounds an entrance opening for the insertion of a temperature sensor, and the filter cloth (6) is sealingly fused and pressed along its outer edge with the tray frame (2) and around the passage opening with the adjoining material of the measuring sensor sleeve (8) in each case using heated tool welding.

2. The freeze-drying tray according to claim 1, characterized in that opposing edges of the first projection (4) are connected to each other via at least one transverse bar (11), preferably in a cruciform shape, which for their part have a passage opening, which corresponds to the passage opening of the filter cloth (6) and through which the measuring sensor sleeve (8) is passed or on which it rests in a sealing manner.

3. The freeze-drying tray according to claim 1, characterized in that a screw connection (12) is assigned to the measuring sensor sleeve (8) for a precisely positioned fastening of a temperature sensor that can be inserted through the screw connection (12) into the measuring sensor sleeve (8).

4. The freeze-drying tray according to claim 3, characterized in that the screw connection (12) is a steel conduit thread.

5. The freeze-drying tray according to claim 1, characterized in that the tray frame (2) and/or the measuring sensor sleeve (8) are produced in each case from polyethylene, polypropylene or polyester.

6. The freeze-drying tray according to claim 1, characterized in that the measuring sensor sleeve (8) has a metallic contact surface (10) on its free end.

7. The freeze-drying tray according to claim 1, characterized in that the filter cloth (6) is produced from a polytetrafluorethylene membrane, which is laminated on a polytetrafluorethylene carrier.

8. The freeze-drying tray according to claim 1, characterized in that the filter cloth (6) is made of a polytetrafluorethylene membrane, which is laminated on a carrier made of polyethylene, polypropylene or polyester.

9. The freeze-drying tray according to claim 1, characterized in that the tray frame (2) has, on its side opposite from the first projection (4), another free edge with a second projection (5), on which a cover film (7) is affixed, preferably welded on.

10. The freeze-drying tray according to claim 9, characterized in that the cover film (7) is produced from the same material as the tray frame (2).

11. The freeze-drying tray according to claim 1, characterized in that the tray frame (2) forms a closed cover on its side opposite from the first projection (4).
